(19) United States
(12) Patent Application Publication
(10) Pub. No.: US 2012/0244050 A1
(43) Pub. Date: Sep. 27, 2012

(54) CLEANING AGENT FOR SILVER-CONTAINING COMPOSITION, METHOD FOR REMOVING SILVER-CONTAINING COMPOSITION, AND METHOD FOR RECOVERING SILVER

(75) Inventors: Christopher J. WARGO, Somerset, NJ (US); Kimitaka Sato, Okayama-shi (JP)

(73) Assignee: DOWA ELECTRONICS MATERIALS CO., LTD., Tokyo (JP)

(21) Appl. No.: 13/071,865

(22) Filed: Mar. 25, 2011

(51) Int. Cl. C01G 5/02; C11D 9/10

(52) U.S. Cl. 423/42; 510/170

(57) ABSTRACT

A cleaning agent for a silver-containing composition is provided which can readily remove silver adhered to an object to be cleaned with excellent operability and low environmental loads. This cleaning agent for the silver-containing composition includes an iron nitrate aqueous solution and used to remove silver derived from a composition containing silver nanoparticles having an average diameter of 1 nm to 100 nm adhered to the object to be cleaned.

### BACKGROUND OF THE INVENTION

1. Field of the Invention

The present invention relates to a cleaning agent for silver-containing compositions, and in particular to a cleaning agent used to remove silver derived from a silver-nanoparticle composition adhered to an object to be cleaned. The present invention also relates to a cleaning method with the cleaning agent and a method for recovering the silver.

2. Description of the Related Art

In recent years, attention has been given to technologies concerned with “printed electronics” that enables easy formation of large amounts of traces and conductive films with the application of existing printing techniques and metal ink or paste.

Compositions used in “printed electronics” contain different metal species and the particle diameters of the contained metal species are also different according to objects to which the compositions are applied. It is well known that silver particles having an average primary-particle diameter of 100 nm or less (hereinafter, also referred to as “silver nanoparticles”) can be sintered at low temperatures and exhibit excellent conductivity. With a printing method using compositions containing the silver nanoparticles, conductive traces can be formed even on substrates, which have been considered to be difficult to use due to their low heat resistance, such as a PET (polyethylene terephthalate) film and paper.

In recent years, increasing environmental and safety concerns have encouraged a shift from conventionally used organic-solvent based printing ink to aqueous printing ink mainly containing water as a solvent. For the same reasons, instead of conventionally used ink or paste, which is one of the silver-nanoparticle compositions containing organic solvents, compositions containing a water solvent and water-dispersible silver nanoparticles have been studied (see, e.g., Japanese Unexamined Patent Application Publication No. 2005-310703 and WO2008/048316).

### SUMMARY OF THE INVENTION

It is possible to obtain printed matter with silver-nanoparticle compositions as represented by the aqueous ink containing silver nanoparticles in Publication No. 2005-310703; however, the aqueous ink remaining on printing machinery parts used to obtain the printed matter may leave the ink components including silver nanoparticles tenaciously adhered to the printing machinery parts after the solvent dries up or disappears for other reasons. It has been revealed that the tenaciously adhered components containing the silver nanoparticles are very difficult to remove even if the solvent used in the aqueous ink, diluents or commercial cleaning products are used.

Especially, anilox rolls for flexographic printing, flexographic plate, gravure plate, screen plate and other printing machinery parts are often contain pits, pores, or crevices. Once the silver nanoparticles enter the fine pores and adhere, cleansing of the silver nanoparticles would be extremely difficult. In a case of using aqueous ink exhibiting excellent sintering behavior at low temperatures, for example, lower than 150° C., leaving the aqueous ink on the printing machinery parts during replacement of a plate, anilox roll or substrate, or suspension of printing equipment due to troubles at the facilities may cause the component containing silver nanoparticles to firmly adhere to the printing machinery parts.

In the case using conventional paste containing silver particles with relatively large diameters, even if the paste that has adhered to a plate is left alone, the relatively large-diameter silver particles have a lower chance of entering the fine pores and can be relatively easily removed through cleaning operations with dedicated cleaning agents or cleaning brushes. However, ink containing silver particles with diameters of the order of nanometers, which are suitable for printed electronics, allows the silver nanoparticles to easily enter inside the fine pores formed in the plate and anilox roll because of the extremely small particle diameters. Then, the solvent dries up while the ink is left standing for a short period of time, which causes the components including the silver nanoparticles to tenaciously adhere to the pores. General cleaning agents and brushes have difficulties removing the silver nanoparticles from the fine pores.

It is possible to employ a method for dissolving and removing the silver nanoparticles with the simple use of acid; however, the method may cause the following problems: the materials of printing machinery parts and some other relevant parts of printing equipment are limited to high acid resistant materials; inadequate cleaning after removal of the silver nanoparticles may affect the next printing operation; and, furthermore, acid of some kinds generates malodorous gas or corrosive gas, and such gases are sometimes inappropriate in working environment.

For simple removal of the silver nanoparticles through dissolution, it may be possible to use bleaching solutions, bleach fix solutions or etchants, which mainly contain a chelating agent such as EDTA (ethylenediaminetetraacetic acid) ferric ammonium and PDTA (propanediaminetetraacetic acid) ferric ammonium used for silver halide photography. The chelating agent used in manufacturing fields is inherently expensive. There may be no problem to use the chelating agent for photographic developing, because only small amounts are needed; however, it is financially inappropriate to regularly use large amounts of the chelating agent for objects with large areas, like plates and anilox rolls. In addition, the ingredients of the bleaching agent mainly containing the EDTA ferric ammonium are principally organic substances. Such components are stable materials, but have problems with disposal in view of environmental concerns, and therefore it is not appropriate to use large amounts of the components.

An object of the present invention is to provide a cleaning agent for a silver-containing composition or a silver-nanoparticle composition. The cleaning agent can remove a component containing silver nanoparticles adhered to an object to be cleaned with excellent operability and low environmental loads. Another object of the present invention is to provide a method for removing the silver-containing composition with the cleaning agent and to provide a silver-recovery method for separating and collecting silver from the waste liquid used for cleaning.

The inventors diligently studied the above-mentioned problems and found out that the cleaning agent with iron nitrate dissolved therein could dissolve the silver component and efficiently remove it, consequently presenting the present invention. Specifically, the cleaning agent for the silver-nanoparticle composition according to the present invention is used to remove silver derived from silver particles of 1 nm to 100 nm in diameter on average adhered to the object to be cleaned. The cleaning agent contains an iron nitrate aqueous solution.

The silver nanoparticles, which are a base of the silver-containing composition to be treated, are, for example, in the form of ink or paste that contains silver particles or silver alloy particles having an average diameter of 1 nm to 100 nm.

The object to be cleaned includes printing plates and printing machinery parts. The parts on which the cleaning agent of the present invention can exert its effect more efficiently are ones having fine pores, such as anilox rolls used in flexographic printing and flexographic plates, gravure plates and screen plates.

The iron nitrate aqueous solution containing 1% to 50% by mass of iron nitrate can be an efficient cleaning agent. Iron nitrate is preferably iron (III) nitrate (chemical formula: Fe(NO₃)₃) containing trivalent iron.

The method for removing a silver-containing composition is a method for removing silver derived from a composition containing silver nanoparticles having an average diameter of 1 nm to 100 nm adhered to an object to be cleaned. The method includes a step of removing the silver-containing composition adhered to the object with a cleaning agent containing an iron nitrate aqueous solution.

According to the removal method, the component derived from silver nanoparticles adhered to the object is readily removed with excellent operability and low environmental loads.

In the method for recovering silver, chloride is added to waste liquid obtained through the above removal method to recover the silver.

In the cleaning performed with the cleaning agent according to the present invention, the silver-containing composition adhered to the object to be cleaned, more specifically the silver-nanoparticle composition filled in fine pores can be readily separated from the object to be cleaned through dissolution. In addition, the cleaning agent that contains no organic substance, such as a chelating agent, reduces environmental loads, while the cleaning agent that contains no acid increases operability.

### DETAILED DESCRIPTION OF THE INVENTION

### (Iron Nitrate)

The iron nitrate aqueous solution used in the present invention has an iron nitrate content of 50% by mass or less, preferably from 1% to 50% by mass, more preferably from 5% to 50% by mass. If the iron nitrate content exceeds 50% by mass, the iron nitrate may precipitate depending on the temperature of the solution, which is not preferable. Raising the solution temperature can curb precipitation, but facilitates the generation of insoluble iron compounds, such as iron oxide and iron hydroxide, in the solution. For storage of the solution in a room temperature, it is therefore preferable to set the iron nitrate content to 50% by mass or less. On the other hand, a solution with an inadequate content of iron nitrate, for example, with an iron nitrate content of less than 1% by mass produces a certain cleaning effect, but the effect takes a long time to be exerted.

Although either kinds of iron nitrate can be used, iron (III) nitrate (also known as ferric nitrate) Fe(NO₃)₃ is preferable, and Fe(NO₃)₃.9H₂O (nonahydrate) is more preferable from the viewpoint of handling and availability.

### (Solvent)

The main ingredient (the mixture ratio is more than half) of the solvent dissolving the iron nitrate to produce an effective solution is water. If the silver nanoparticle composition contains resin or binder, a solvent, such as alcohol and polyol, that dissolves the component of the resin or binder can be added for the purpose of enhancing the cleaning effect. The use of solubilizer with a boiling point higher than water can retard drying of the aqueous solution and therefore curb the drying rate of the solution on the printing machinery parts, thereby enhancing the cleaning effect.

The water used as the solvent is preferably distilled water or de-ionized water. If chlorine remains in the solution, insoluble silver chloride may be produced with silver dissolved in the solution, which should be avoided with extra caution. However, the chlorine in an appropriate concentration range as drinking water substantially does not cause problems, and therefore general industrial water and tap water can be used.

In addition, if oxygen remains in the solution, iron oxide and iron hydroxide may be produced in the solution, and therefore it is preferable to remove oxygen that is degassing, during solution preparation. Degassing of oxygen is performed by circulating nitrogen, which is an inert gas, through the solution. However, the oxygen in the same concentration range as that of general industrial water and tap water substantially does not cause problems.

### (Preparation of Cleaning Agent)

The iron nitrate is dissolved in the solvent to prepare an iron nitrate aqueous solution with necessary additives. After the preparation, it is appropriate to store the iron nitrate aqueous solution in a dark, cool place for the purpose of suppressing precipitation of insoluble oxide and hydroxide; however, insoluble precipitation to a certain extent do not greatly affect the cleaning effect.

The iron nitrate aqueous solution prepared in the above-described manner is a relatively low volatile solution that improves the usage environment. Unlike acid, the iron nitrate aqueous solution has a low corrosive property to metal, which may be the material of the objects to be cleaned, and therefore the iron nitrate aqueous solution can help prolong printing machinery parts' longevity.

Furthermore, the cleaning agent in the form of an aqueous solution is highly permeable to the objects to be cleaned and can easily enter even fine pores. The effective action of the cleaning agent to the silver-containing compositions embedded in the minute pores provides excellent removal function.

An example of cleaning methods is shown below, but does not limit the present invention.

### (Cleaning Method)

In the case where an object to be cleaned is a relatively small part, a recommended cleaning method is to soak the part in the cleaning solution, which is a cleaning agent, and to brush the part after being taken out from the solution. Occasionally, ultrasonic wave can be applied to the part from the outside of a chamber filled with the cleaning solution to remove the silver-containing composition embedded in the fine pores. The part cleaned by a cleaning brush is subjected to sufficient water washing. The water washing before the iron nitrate aqueous solution is dried enhances the cleaning effect. To enhance the cleaning effect more, brushing can be performed simultaneous with the water washing. It is needless to say that ultrasonic wave can be applied during the water washing.

In the case where an object to be cleaned is a relatively large part, the part is applied with the cleaning solution by a brush, is scrubbed for a predetermined period of time by a cleaning brush after the application of the solution, and is sufficiently washed with water. The brush, which is used to apply the solution to the part, can be replaced with a waste rag or the like. The waste rag soaked with the solution is put on the part for a predetermined period of time and then taken off, which provides higher cleaning effect together with subsequent brushing and water-washing.

The conditions (processing temperature, concentration of the cleaning agent, processing time) of the cleaning and water-washing are appropriately adjustable according to factors including the contamination status, dimension and shape of parts. For example, a large part is required to be cleaned within a relatively short time, and therefore it is preferable to increase the content ratio of the iron nitrate, specifically to approximately 25% by mass or higher. On the other hand, a small part, for which more cleaning time is permitted, may be soaked in the cleaning solution with an iron nitrate content of approximately 25% by mass or less. Thus, the percentage of the iron nitrate content and temperature are adjustable according to the size and cleaning time of the parts.

### (Silver-Containing Composition to be Removed)

The silver-containing composition, or silver-nanoparticle composition, to be removed during the cleaning process according to the present invention contains silver (single element) particles or silver alloy particles having an average primary-particle diameter of 1 nm to 100 nm and is provided in the form of ink or paste that will be metalized. The paste and ink containing metallic nanoparticles with an average diameter within such a range are formed into metalized traces at a low temperature. Such paste and ink are effective as conductive materials, but enter even fine pores of printing machinery parts and are metalized during drying. The metalized paste and ink are very difficult to remove. The diameter of the particles is measured, for example, by the following method.

### (Evaluation of Average Primary-Particle Diameter)

The diameter of the silver nanoparticles in this description denotes an average primary-particle diameter that is an average value of primary particles' diameters obtained from TEM (Transmission Electron Microscope) images and was measured as follows: 2 parts by mass of silver nanoparticle composition were added to a mixed solution of 96 parts by mass of cyclohexane and 2 parts by mass of oleic acid and were dispersed by ultrasonic wave; the solution with the dispersed silver nanoparticle composition was dropped onto a Cu micro grid with a support film and dried to create a TEM specimen; and the prepared microgrid is observed with a transmission electron microscope (JEM-100CXMark-II manufactured by JEOL ltd.) at an acceleration voltage of 100 kV in a bright field to capture particle images at 300,000-fold magnification.

The average primary-particle diameter was calculated with image analysis software (A-zo kun (trade name) manufactured by Asahi Kasei Engineering Corporation) that identified individual particles based on darkness and brightness of colors. A circular particle analysis of the TEM images at 300,000-fold magnification was conducted under the following conditions: “brightness of particles” was set to “darkness”; “noise elimination” was “ON”; “circular threshold” was set to “20”; and “overlap degree” was set to “50”. The diameters of more than 200 primary particles were measured and their average, or their average primary-particle diameter, was obtained. TEM images with many aggregated particles and irregular-shaped particles were determined to be immeasurable.

For the purpose of rheological adjustment, silver or silver alloy particles (hereinafter, also simply referred to as “silver powder”) with a diameter exceeding 100 nm can be added in the composition. However, because excessive amounts of such particles may impair the low-temperature sintering property of the composition, silver nanoparticles need to be the main ingredient. To be the main ingredient, the silver nanoparticles need to make up 50% or more by mass of the total metallic ingredient.

The composition containing the silver nanoparticles combined with water as the main ingredient can change into an excellent composition in natural and working environments.

Additives, such as a pH adjuster and viscosity modifier, can be appropriately added to the composition containing the silver nanoparticles in accordance with the printing method.

### (Recycling of Waste Liquid)

The waste liquid generated in the present invention, in other words, the waste cleaning solution derived from cleaning with the cleaning agent to remove the silver-containing composition, is made of obvious ingredients, that is, iron, silver, nitrate and water. Methods for recovering iron and silver from the waste liquid have been already established. It is also preferable to combine these methods to separate and recover the silver from the waste liquid and reuse the silver.

One exemplary recovery method will be described. When silver is dissolved in the iron nitrate aqueous solution during the cleaning process, the dissolution of the silver sometimes causes iron ion to be precipitated as iron oxide or iron hydroxide depending on the solution environment. When precipitation has occurred, the solution with the dissolved silver is filtered once to remove the iron oxide or iron hydroxide precipitations, and a substance including chloride ion (hydrochloric acid, NaCl aqueous solution, KCl aqueous solution, etc.) is added to the filtered solution to settle the silver as silver chloride for recovery. Adding NaOH or aqueous ammonia into the remaining solution makes it possible to recover iron as hydroxide. The easy silver recovery and waste liquid treatment are features of the present invention.

A more specific example of silver recovery will be described below.

(a) The iron (III) nitrate aqueous solution is filtered with a Teflon (trade name) filter with a pore size of 0.1 μm to remove foreign substances in the solution. When silver and silver compounds are soaked in the iron (III) nitrate solution, the silver dissolves in the solution and iron ion is precipitated as iron oxide or iron hydroxide depending on the solution environment. These foreign substances are removed by the filter.

(b) After the removal of the foreign substances by filtering, a KCl aqueous solution of 3.3 mol/l concentration is added to the aqueous solution. The amount of addition is equal to the molar quantity of the iron (III) in the solution. If the amount of the dissolved silver can be estimated, the KCl aqueous solution of approximately 10 times the estimated amount of silver will be added. The precipitated substance is silver chloride.

(c) After the addition, the solution is stirred for a few minutes and the silver chloride is collected by a Teflon filter with a pore size of 0.1 μm. From the weight of the collected silver chloride, the amount of silver is calculated. Adding NaOH to the filtrate settles iron (III) hydroxide, thereby facilitating recovery of iron components from the solution.

The above-described method enables component separation and therefore recovery of both silver and iron. The recovered iron is dissolved in nitric acid and can be reused in the cleaning method.

### (Evaluation of Cleaning Efficiency)

Cleaning effects on objects to be cleaned, such as an anilox roll, before and after the removal process were examined with a digital microscope by observing the state of silver in grooves to check whether the silver is fully removed.

### (Flexographic Printing)

An exemplary flexographic printing method will be described below.

Cleanliness evaluation of an anilox roll, which is one of the parts used in flexographic printing, can be made by the following method.

### (Flexographic Ink)

The used flexographic ink was Model PFI-700 containing approximately 60% by mass of silver, manufactured by PChem Associates Inc.

### (Flexographic Printing Equipment)

Flexographic Proof (Manufacturer: RK Print Coat Instruments, Model: ESI12, anilox roll: volume of 2.6 BCM (billion cubic microns per square inch) (600 lines/inch), 13.5 BCM (120 lines/inch) was used.

### (Flexographic Printing Steps)

The flexographic proof was set to regulate pressure between the anilox roll and rubber plate. With regulating knobs at both sides of the flexographic proof, the anilox roll and rubber plate in the state where they had surface contact were pressed against each other by 0.05 mm to 0.10 mm. Then, the composition of approximately 1 ml was dropped onto the anilox roll to apply the composition to a PET (polyethylene terephthalate) film (Melinex (trade name) 545 manufactured by Teijin DuPont Films Japan Limited) in approximately one second.

### (Calculation of Silver Removal Rate of Anilox Roll in Cleaning Process)

### (Initial Volume)

An anilox roll was soaked in an aqueous solution with 30% by mass of nitric acid for 30 minutes and then was fully washed with water and dried. After ensuring that the temperature of the anilox roll was in a range between 20° C. to 25° C., the cell volume of the anilox roll was measured by a laser microscope VK9700 manufactured by Keyence Corporation. The measuring result is defined as the initial volume of the anilox roll. The used unit is BCM.

(Volume after Charging)

Printing processes were performed according to the above-described flexographic printing steps, and then the anilox roll was dried at room temperature for 24 hours. After ensuring that the temperature of the anilox roll was in the range between 20° C. to 25° C., the cell volume of the anilox roll was measured by the laser microscope. The measuring result is defined as the volume of the anilox roll with ink charged.

(Volume after Cleaning)

The anilox roll was washed by the predetermined method and fully dried. After ensuring that the temperature of the anilox roll was in the range between 20° C. to 25° C., the cell volume of the anilox roll was measured by the laser microscope. The measuring result is defined as the volume of the cleaned anilox roll.

### (Removal Rate)

The removal rate is defined as follows:

Removal rate (%)=[{(initial volume−volume after charging)−(initial volume−volume after cleaning)}/(initial volume−volume after charging)]×100

The silver removal rate of 100% to 90% receives a score of “good”, the silver removal rate of 90% to 80% receives a score of “fair”, the silver removal rate of less than 80% receives a score of “poor”.

### (Gravure Printing)

An exemplary gravure printing method will be described below. Cleanliness evaluation of a gravure plate, which is one of the parts used in gravure printing, can be made by the following method.

### (Gravure Ink)

The used gravure ink was Model PGI-700 containing approximately 60% by mass of silver, manufactured by PChem Associates Inc.

### (Gravure Printing Equipment)

K Printing Proofer (Manufacturer: RK Print Coat Instruments, gravure plate: 300 lines/inch, 100 lines/inch) was used.

### (Calculation of Silver Removal Rate of Gravure Plate in Cleaning Process)

As with the above case, the removal rate was calculated with similar evaluation equipment and formula with the “initial volume”, which was the cell volume of the gravure plate washed with nitric acid, “volume after charging”, which was the cell volume after printing and drying steps, and “volume after cleaning”, which was the volume after the cleaning step. The silver removal rate of 100% to 90% receives a score of “good”, the silver removal rate of 90% to 80% receives a score of “fair”, and the silver removal rate of less than 80% receives a score of “poor”.

### (Screen Printing)

An exemplary screen printing method will be described below. Cleanliness evaluation of a screen plate, which is one of the parts used in screen printing, can be made by the following method.

### (Screen Ink)

The used screen ink was Model PSI-111 containing approximately 40% by mass of silver, manufactured by PChem Associates Inc.

### (Screen Printing Equipment)

A screen printer (manufacturer: C. W. Price Co., Model: 224, screen: PET mesh, 420 line/inch, 23 μm line diameter) was used.

### (Calculation of Silver Removal Rate of Screen Plate in Cleaning Process)

After performing printing processes with the ink under the printing conditions, unnecessary ink was removed by a rubber squeegee from the screen plate that was then dried for 24 hours. The dried screen plate was observed by a microscope and it was found out that the pores of its mesh were 100% clogged with ink. This screen plate was washed with the iron (III) nitrate aqueous solution and observed by the microscope in the same manner, and the removal rate was determined by dividing the number of the completely cleaned mesh pores within 5 mm square by the total number of mesh pores within 5 mm square. The silver removal rate of 100% to 90% receives a score of “good”, the silver removal rate of 90% to 80% receives a score of “fair”, and the silver removal rate of less than 80% receives a score of “poor”.

### (Odor)

Prepared cleaning solutions were subjected to sensory analysis to examine their odor. As criteria, if no odor was sensed, the cleaning solution was determined “very good”, if a very slight odor was sensed, the cleaning solution was determined “good”, if a slight odor was sensed, the cleaning solution was determined “fair”, and if an obvious odor was sensed, the cleaning solution was determined “poor”.

### EXAMPLES

The present invention will be described below with examples; however, the present invention is not limited to the examples.

### Example 1

Iron (III) nitrate nonahydrate (chemical formula: Fe(NO₃)₃.9H₂O) was dissolved in tap water to prepare a 50% by mass iron (III) nitrate aqueous solution in terms of iron (III) nitrate, consequently providing “a cleaning solution”. The aqueous solution was found to have a slight odor derived from the nitric acid (a score of “fair”). Then, flexographic printing was performed with a silver-nanop article composition (Manufacturer: PChem, Model: PFI-700, Silver concentration: 60% by mass, Primary particle diameter: 22 nm) and flexographic printers (with 2.6 BCM and 13.5 BCM anilox rolls, respectively, with ceramic-coated surfaces). After a 24-hour suspension from the printing operation, the cleaning solution was applied on the anilox roll with a brush. The roll was scrubbed with a cleaning brush and water 10 minutes after the application of the solution. On the assumption that a large printer with a hard-to-remove anilox roll is used, the brush was used to apply the cleaning agent to the roll. The evaluations of cleaning efficiency made by use of the digital microscope show that the silver-nanoparticle composition was completely removed from both the 2.6 BCM and 13.5 BCM anilox rolls, and therefore the cleaning solution receives a score of “good”.

### Example 2

With a 25% by mass iron (III) nitrate aqueous solution in terms of iron (III) nitrate, evaluation of the solution was made under the same conditions as Example 1. The solution was found to have a slight odor (a score of “fair”). The evaluation shows that the silver was completely removed from both the 2.6 BCM and 13.5 BCM anilox rolls, and therefore the cleaning solution receives a score of “good”.

### Example 3

A 10% by mass iron (III) nitrate aqueous solution was prepared as a cleaning solution. The solution was found to have a slight odor. Then, flexographic printing was performed with a silver-nanoparticle composition (Manufacturer: PChem, Model: PFI-700, Silver concentration: 60% by mass) and flexographic printers (2.6 BCM and 13.5 BCM anilox rolls, respectively, with ceramic-coated surfaces). After a 24-hour suspension from the printing operation, the anilox roll was soaked in the cleaning solution. The roll was taken out of the cleaning solution after soaking for 6 hours and scrubbed with a cleaning brush and water. This cleaning method was employed on the assumption that a small printer that can be disassembled would be used. The evaluation of cleaning efficiency shows that the silver composition was almost completely removed from both 2.6 BCM and 13.5 BCM anilox rolls, and therefore the cleaning solution receives a score of “good”.

Following the cleaning process, the iron (III) nitrate aqueous solution was divided into two parts. One of the parts was subjected to an ICP atomic emission spectrometer to determine the quantity of silver, while the other is subjected to gravimetry for measuring the weight of silver chloride obtained through the above-described silver covering process to determine the quantity of the silver in order to verify the effectiveness of the process.

The iron (III) nitrate aqueous solution subjected to the ICP atomic emission spectrometer contained 269 ppm of silver, while the iron (III) nitrate aqueous solution subjected to the silver chloride gravimetry contained 271 ppm of silver, resulting in that their concentration values are approximately the same. This proved that the recovery process can collect almost all the silver.

### Examples 4 and 5

With cleaning solutions with an iron (III) nitrate concentration of 5% (Example 4) and 1% (Example 5), evaluations of the cleaning solutions were made under the same conditions as Example 2. Evaluations of odor and cleaning efficiency were made in the same manner as Example 1. The solutions of Examples 4, 5 were found to have no odor. The cleaning solution with an iron (III) nitrate concentration of 5% removed almost all silver composition from both the 2.6 BCM and 13.5 BCM anilox rolls for six hours and receives a score of “good”. The results are shown in Table 1 all together.

The removal rates of the cleaning solution with an iron (III) nitrate concentration of 1% for six hours are 60% or less for both the 2.6 BCM and 13.5 BCM anilox rolls and revealed insufficient cleaning efficiency. However, the cleaning efficiency was improved by soaking the rolls in the solution for 24 hours and receives a score of “good” for the 2.6 BCM anilox roll and “fair” for the 13.5 BCM anilox roll, which are in an appropriate range.

### Example 6

Iron (III) nitrate nonahydrate (chemical formula: Fe(NO₃)₃.9H₂O) is dissolved in tap water to prepare a 10% by mass iron (III) nitrate aqueous solution in terms of iron (III) nitrate, consequently providing “a cleaning solution”. The solution was found to have a slight odor. Then, gravure printing was performed with a silver composition (Manufacturer: PChem, Model: PGI-700, Silver concentration: 60% by mass, Primary particle diameter: 24 nm) and gravure printers (with a 300 lines/inch gravure plate and 100 lines/inch gravure plate, respectively). After a 24-hour suspension from the printing operation, the gravure plates were soaked in the cleaning solution in a container. The plates were taken out of the cleaning solution in six hours and scrubbed with a cleaning brush and water. The evaluation of cleaning efficiency shows that the silver-nanoparticle composition was almost completely removed from both the 300 lines/inch and 100 lines/inch gravure plates, and therefore the cleaning solution receives a score of “good”.

### Example 7

Iron (III) nitrate nonahydrate (chemical formula: Fe(NO₃)₃.9H₂O) was dissolved in tap water to prepare a 10% by mass iron (III) nitrate aqueous solution in terms of iron (III) nitrate, consequently providing “a cleaning solution”. The solution was found to have a slight odor. Then, screen printing was performed with a silver composition (Manufacturer: PChem, Model: PSI-111, Silver concentration: 40% by mass, Primary particle diameter: 21 nm) and screen printer (with a PET mesh screen plate of 420 lines/inch and 23 μm line diameter).

Following the printing operation, excess ink was removed by a rubber scraper. After a 24-hour suspension from the printing operation, the screen plate was soaked in the cleaning solution in a container. The screen plate was taken out of the cleaning solution in six hours and scrubbed with a cleaning brush and water. The evaluation of cleaning efficiency shows that the silver composition was almost completely removed from the screen plate, and therefore the cleaning solution receives a score of “good”.

### Comparative Example 1

Instead of the iron (III) nitrate aqueous solution used in Example 1, Ceram Clean II (manufactured by Harper Corporation) was used which was a cleaning agent containing a ceramic-based abrasive and generally used to physically clean anilox rolls. In addition to 2-minute scrubbing with a waste rag dampened with the cleaning agent, the procedure in Example 1 was performed. The evaluation shows that Ceram Clean II removed approximately 83% of silver-nanoparticle composition from the 2.6 BCM anilox roll, but nothing from the 13.5 BCM anilox roll. It can be understood that the 13.5 BCM anilox roll is too large and its cells are too deep to receive the cleaning effect.

### Comparative Example 2

Instead of the iron (III) nitrate aqueous solution used in Example 1, Anilox Roll Cleaner (manufactured by Anilox Roll Services) was used which was a glycol ether-based cleaning agent and generally used to chemically clean anilox rolls. In addition to 2-minute scrubbing with a sponge dampened with the cleaning agent, the procedure in Example 1 was performed. The removal rates of Anilox Roll Cleaner for both the 2.6 BCM and 13.5 BCM anilox rolls were 40% or less.

### Comparative Example 3

Instead of the iron (III) nitrate aqueous solution used in Example 1, Palmolive, a commercial dishwashing detergent manufactured by Colgate-Palmolive Company, was used. In addition to 2-minute scrubbing with a water-soaked sponge dampened with the cleaning agent, the procedure in Example 1 was performed. The removal rates with Palmolive for both the 2.6 BCM and 13.5 BCM anilox rolls were 40% or less.

These comparative examples proved that conventional cleaning agents do not provide sufficient effect. Evaluation results are shown in Table 1 all together.

### Comparative Example 4

The procedure in Example 3 was performed with a 10% nitric acid aqueous solution instead of iron (III) nitrate. Evaluation results are shown in Table 1. The solution exhibits a high cleaning efficiency, but has a strong odor that is not appropriate for continuous use.

[Table 1]

[Table 2]

[Table 3]

The cleaning agent according to the present invention efficiently removes silver existing in fine cavities and hardly generates odor inherent in the used chemical. The cleaning agent is therefore excellent from the point of the working environment and expected to be widely applied in the printed electronics fields.

TABLE 1

| | Composition of Cleaning | | Evaluation of Cleaning Efficiency | | | | |
|---|---|---|---|---|---|---|---|
| | Agent | | 2.6 BCM | | 13.5 BCM | | |
| | Cleaning | | Removal | | Removal | | |
| | Component | Content | Rate | Evaluation | Rate | Evaluation | Odor |
| Example 1 | Iron (III) Nitrate | 50% | 100% | Good | 100% | Good | Good |
| Example 2 | Iron (III) Nitrate | 25% | 100% | Good | 100% | Good | Good |
| Example 3 | Iron (III) Nitrate | 10% | 100% | Good | 97% | Good | V. Good |
| Example 4 | Iron (III) Nitrate | 5% | 98% | Good | 95% | Good | V. Good |
| Example 5 | Iron (III) Nitrate | 1% | 90% | Good | 80% | Fair | V. Good |
| Comparative | Ceram Clean II | — | 83% | Fair | 3% | Poor | V. Good |
| Example 1 | | | | | | | |
| Comparative | Anilox Roll | — | 39% | Poor | 4% | Poor | Poor |
| Example 2 | Cleaner | | | | | | |
| Comparative | Palmolive | — | 36% | Poor | 2% | Poor | V. Good |
| Example 3 | | | | | | | |
| Comparative | Nitric Acid | 10% | 100% | Good | 100% | Good | Poor |
| Example 4 | | | | | | | |

TABLE 2

| | Composition of Cleaning | | Evaluation of Cleaning Efficiency | | | | |
|---|---|---|---|---|---|---|---|
| | Agent | | 300 lines/inch | | 100 lines/inch | | |
| | Cleaning | | Removal | | Removal | | |
| | Component | Content | Rate | Evaluation | Rate | Evaluation | Odor |
| Example 6 | Iron (III) Nitrate | 10% | 100% | Good | 98% | Good | V. Good |

TABLE 3

| | | | Evaluation | | |
|---|---|---|---|---|---|
| | Composition | | of Cleaning | | |
| | of Cleaning | | Efficiency | | |
| | Agent | | PET mesh | | |
| | Cleaning | | Removal | | |
| | Component | Content | Rate | Evaluation | Odor |
| Example 7 | Iron (III) | 10% | 97% | Good | V. Good |
| | Nitrate | | | | |

1. A cleaning agent for a silver-containing composition, the cleaning agent being used to remove silver derived from a composition containing silver nanoparticles having an average diameter of 1 nm to 100 nm adhered to an object to be cleaned, the cleaning agent comprising:
an iron nitrate aqueous solution that contains iron nitrate in a range of from 1% to 50% by mass, wherein the iron nitrate is dissolved in water to prepare the iron nitrate aqueous solution without nitric acid.

2. (canceled)

3. The cleaning agent for the silver-containing composition according to claim 1, wherein the iron nitrate is iron (III) nitrate (chemical formula: Fe(NO₃)₃).

4. The cleaning agent for the silver-containing composition according to claim 1, wherein the object to be cleaned is a printing plate or printing machinery part.

5. A method for removing a silver-containing composition, the method being used to remove silver derived from a composition containing silver nanoparticles having an average diameter of 1 nm to 100 nm adhered to an object to be cleaned, the method comprising the step of:
removing the silver-containing composition adhered to the object to be cleaned with a cleaning agent containing an iron nitrate aqueous solution that contains iron nitrate in a range of from 1% to 50% by mass, wherein the iron nitrate is dissolved in water to prepare the iron nitrate aqueous solution without nitric acid.

6. (canceled)

7. The method for removing the silver-containing composition according to claim 5, wherein the object to be cleaned is a printing plate or printing machinery part.

8. A method for recovering silver comprising the step of:
separating and collecting silver from a silver-containing waste cleaning solution obtained through the method for removing the silver-containing composition according to claim 5, wherein in the step of separating and collecting the silver, hydrochloric acid or KCL aqueous solution is added to the silver-containing waste cleaning solution to precipitate the silver as silver chloride.

9. (canceled)
